(19) United States
(12) Patent Application Publication
(10) Pub. No.: US 2015/0339404 A1
(43) Pub. Date: Nov. 26, 2015

(54) INFERRING SENIORITY LEVEL OF A MEMBER OF AN ON-LINE SOCIAL NETWORK

(71) Applicant: LinkedIn Corporation, Mountain View, CA (US)

(72) Inventors: Suman Sundaresh, Cupertino, CA (US); Trevor Walker, San Francisco, CA (US); Deepak Kumar, Mountain View, CA (US); Vaibhav Goel, Mountain View, CA (US)

(73) Assignee: LinkedIn Corporation, Mountain View, CA (US)

(21) Appl. No.: 14/286,908

(22) Filed: May 23, 2014

(51) Int. Cl. G06F 17/30; G06F 21/62

(52) U.S. Cl. CPC G06F 17/30941; G06F 17/30221; G06F 17/30997; G06F 17/30864; G06F 21/6227; G06Q 50/01

(57) ABSTRACT

An inferred seniority system, in one example embodiment, may be configured to determine seniority levels for member profiles maintained by an on-line social network system, based on information stored in the member profiles, and also based on a hierarchical structure termed a seniority pyramid. The system may first determine seniority labels for each of the profiles in a group of member profiles based on information in respective member profiles. The system then determines, for groups of profiles that are given their respective seniority labels, percentages of profiles associated with respective seniority labels. Respective seniority levels for the groups of profiles are determined based on respective percentages of profiles associated with respective seniority labels and the percentage ranges associated with seniority levels that are stored in the seniority pyramid structure.

### TECHNICAL FIELD

This application relates to the technical fields of software and/or hardware technology and, in one example embodiment, to system and method to infer professional seniority of a member of an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to infer seniority of a social network member may be implemented;

FIG. 2 is block diagram of a system to infer seniority of a social network member, in accordance with one example embodiment;

FIG. 3 is a flow chart of a method to infer seniority of a social network member, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to infer professional seniority of a social network member in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate that member's connection to other members of the social network. A member profile may also include or be associated with comments or endorsements from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information provided by the member's connections. Information provided by the member's connections may be, e.g., recommendations, endorsements and skills. The profile of a member may include several items or units of a profile. For example one unit of a profile may contain information about the member's education, while another unit may contain information about the member's current and past employment. The profile of a member may also include a professional title of the member, such as, e.g., “HR generalist” or “VP of Engineering,” or “Lecturer,” or “Founder,” etc.

Professional title, information about the member's current and past employment, the lists of skills and endorsements, as well as other information that may be found in a member profile, may be indicative of the member's seniority level in their profession. Determining a member's professional level of seniority may be important when a member is being targeted with a particular job listing or, for example, when a member is being targeted with certain advertisements or news items. It may be important that job listings that call for professional experience associated with an executive level are provided to those members of an on-line networking system that have professional experience associated with an executive level. Conversely, it may be important that those members that have professional experience associated with an executive level do not receive job listings that call for professional experience associated with an entry level.

In one example embodiment, method and system to infer seniority of a social network member may be utilized beneficially to determine seniority level of a member of an on-line social network system based on profile information of the member and a so-called seniority pyramid. A seniority pyramid is a hierarchical structure comprising a plurality of seniority levels, where each seniority level is associated with a percentage range of member profiles that belong to that seniority level. For example, a first percentage range in a seniority pyramid may be indicative of a first level of seniority (e.g., the seniority pyramid structure indicates that in a given population of members there are between 1% and 5% of members who are at an executive level of seniority). A second percentage range may be indicative of a second level of seniority (e.g., the seniority pyramid structure may also indicate that in a given population of members there are between 11% and 60% of members who are at a non-executive level of seniority). Seniority levels in a seniority pyramid may include, e.g., the following levels: CEO (chief executive officer), director, vice-president (VP), non-executive level, entry level, etc. This hierarchical structure is referred to as a seniority pyramid or a seniority pyramid structure, because it can be imagined visually that the top of the pyramid represents the highest level of seniority (e.g., CEOs), while the bottom of the pyramid represents the entry level of seniority, as there are fewer senior executive positions in the professional landscape than there are mid-level positions and it may be fair to presume that most people have started a career at an entry level. A seniority level in a seniority pyramid may be identified, e.g., by a numerical value or by an alpha-numeric string. For example, seniority levels may be identified as levels 1 through 20, where level 1 is the highest level of seniority and level 20 is the lowest, or vice versa.

In one embodiment, a seniority pyramid structure maybe constructed based on an assumption that seniority distribution of members of an on-line social network across industries mimics the structure of a typical industry-specific organizational chart of a company (e.g., a company that has greater than one thousand employees or a company that has some other characteristics). Based on this natural structure, industry-specific seniority frequencies may be extracted and sorted in order to arrive at a seniority hierarchy. The method for constructing a seniority pyramid may be optimized in order to obtain better resolution of executive seniority, by distinguishing between certain important seniority levels, such as between senior vice president and vice president, between senior director and director, as well as between other levels and their associated sub-levels. The optimization may be performed utilizing automated scripts for post-processing of title information extracted from member profiles using regular expressions or other methods/algorithms for text processing. An example algorithm for computing a seniority ranking and an executive status identification comprises sorting the member profiles based on industry-specific seniority distributions, assigning to the top 5% of the profiles seniority level of senior executives, assigning to the top 10% seniority levels of executives, and assigning the non-executive level to the remaining member profiles. Member profiles that are used in constructing a seniority pyramid may be filtered to exclude to exclude certain labels, such as, e.g., volunteers, trainees, etc. Initializations may be performed to ensure that Chief Experience Officers (CXOs), senior vice presidents, and owners are considered to be at an executive level of seniority. It will be noted, that the 5% or top 10% cutoffs can be determined in several ways, not limited to (1) visualization of the distributions of the seniority labels in the seniority pyramid, (2) via crowdsourcing validation or (3) via other methods.

A seniority pyramid may be generated for a particular industry for the entire population of the on-line social network, or based on some other subset of member profiles. For example, a seniority pyramid may be generated based on a particular job function, on a particular geo location (e.g., a particular country or a region of a country), on a particular company (e.g., Google only), on a particular company size (a startup versus a large company), on a particular language, etc. Where a seniority pyramid is created for a particular industry, the system selects training data in the form of member profiles that represent members that are or have been employed within a certain industry. An industry associated with a profile maybe determined, e.g., by analyzing past and present employment information provided in the profile. For example, an industry may be inferred from the name of a company that is listed in the profile as a current or past employer of the member represented by the profile. Based on the analysis of the training data, the system identifies a plurality of percentage ranges that determine respective seniority levels. In some embodiments, the training data may be filtered to exclude profiles that represent members that have very brief or no professional experience, e.g., students.

A seniority pyramid may be utilized for determining, for a given group of member profiles, respective seniority levels for various subsets of profiles from the group. As the titles that appear in member profiles in an on-line social network system may vary greatly from industry to industry and from company to company, it may not always be clear whether a particular title corresponds to a certain level of seniority. For example, the titles “principal developer” and “software developer” may correspond to the same level of seniority with respect to the member's professional experience. In one embodiment, a system to infer seniority of a social network member may first determine so-called seniority labels for each of the profiles in a group of member profiles that are associated with a particular industry. The determination of a seniority label may be based on seniority-related words and phrases that may appear in the title section of a member profile, based on skills listed in the member profile, as well as on other information that may be gleaned from a member profile. For example, if a given member profile includes the word “director” in the title section and also includes certain skills associated with the “director” seniority label, that particular profile may be identified with the “director” seniority label.

In one embodiment, the system to infer seniority of a member represented by a profile in an on-line network system determines a list of standardized seniority labels, where a seniority label may be associated with certain criteria, such as, e.g., certain words that may be indicative of seniority (e.g., “senior,” “staff.” or “executive”), certain skills that may be listed in a member profile, etc. For example, a seniority label “senior non-executive position” may be associated with words such as “senior” and “principal” and also with skills such as “management” and “supervision.” A seniority label “mid-level non-executive position” may be associated with words such as “staff” and “associate.” A seniority label “director executive position” may be associated the word “director.” In some embodiments, a list of standardized seniority labels may be generated for a specific industry, and a different list of standardized seniority labels may be generated for a different industry.

After the system to infer seniority determines respective seniority labels for the profiles in a given set of profiles, the system determines, for groups of profiles that are given their respective seniority labels, percentages of profiles associated with respective seniority labels. For example the system may determine that five percent of profiles have been given the label “director” and fifty percent of profiles have been given the label “mid-level non-executive.” The system to infer seniority may then access a seniority pyramid and determine, based on the seniority levels and their respective percentage ranges stored in the seniority pyramid structure that the percentage range between sixty and forty percent corresponds to seniority level “XYZ.” The profiles that have been identified given the label “mid-level non-executive” may be now associated with the seniority level “XYZ.”

The use of a seniority pyramid structure may be beneficial in resolving an ambiguity where in different industries seniority is identified by different words. For example, in banking, the title “VP” is not indicative of an executive level, while in computer industry it is.

In one embodiment, the generating of a seniority pyramid structure may be based on a subset of member profiles from the on-line social network that are associated with a particular industry. The system to infer seniority may be configured to determine member profiles that are associated with a particular industry by accessing a member profile, determining that the member profile includes employer information associated with the particular industry, and identify the member profile as associated with the particular industry.

It will be noted, that a seniority level is distinct from an occupation. For example, a member profile may include a title “senior software engineer,” where this title may be considered to be indicative of the seniority level “non-executive level” and also indicative of the occupation “software engineer.”

As mentioned above, determining a member's professional level of seniority may be important when a member is being targeted with a particular job listing or, for example, when a member is being targeted with certain advertisements or news items. A job listing is typically indicative of a certain level of seniority that is expected of a potential job applicant. The level of seniority associated with a job listing maybe utilized to determine those member profiles that are associated with the same or similar level of seniority. The job listing may then be presented only to those members that are represented by respective profiles associated with the same or similar level of seniority. Furthermore, some advertisement listings or news articles may be also associated with a seniority level, which may be utilized to present these advertisement listings or news articles only to those members that are represented by respective profiles associated with the same or similar level of seniority.

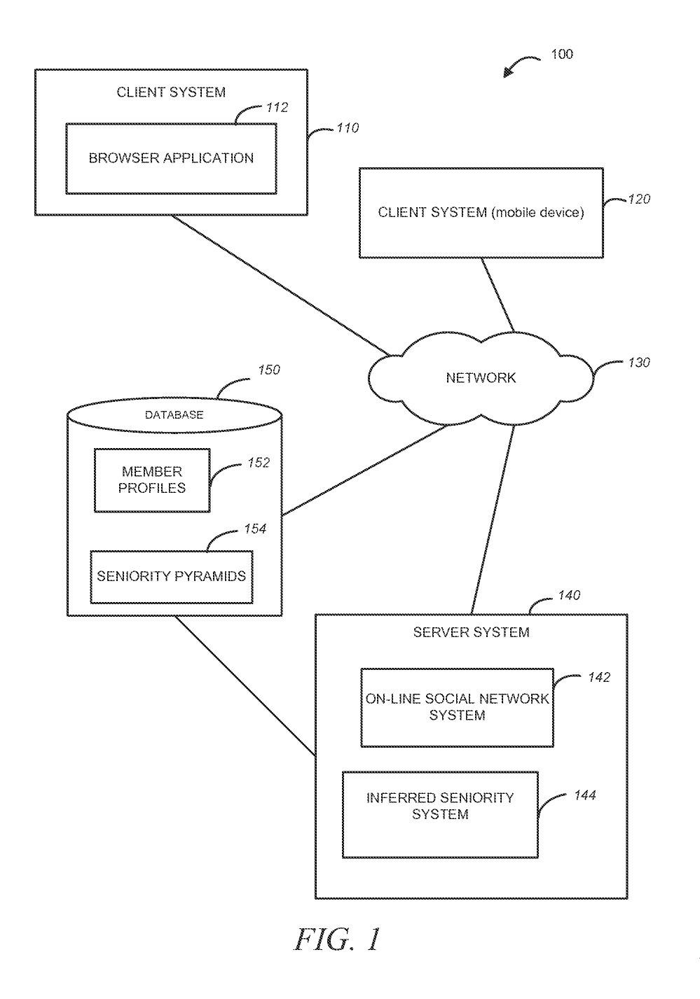

An example method and system to infer seniority level of a social network member may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts an inferred seniority system 144. The inferred seniority system 144 may be configured to determine seniority levels for member profiles in the on-line social network system 142.

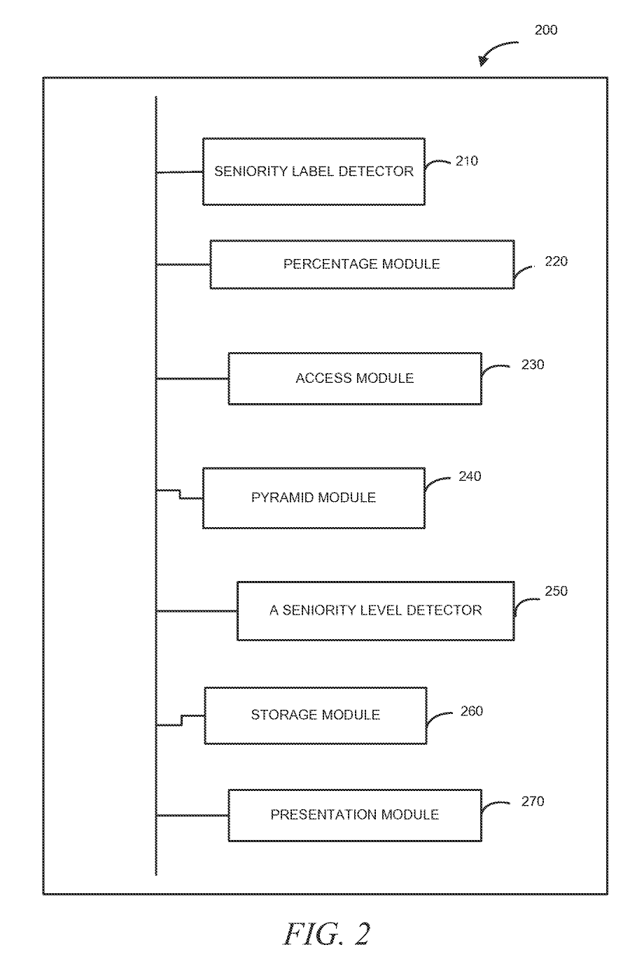

The inferred seniority system 144 may utilize information stored in the member profiles, and also based on a seniority pyramid structure. The inferred seniority system 144 may be configured to first determine seniority labels for each of the profiles the group of member profiles on information that may be obtained from respective member profiles. After the system 144 determines respective seniority labels for the profiles in the given set of profiles, the system 144 determines, for groups of profiles that are given their respective seniority labels, percentages of profiles associated with respective seniority labels. Respective seniority levels for the groups of profiles may be determined based on respective percentages of profiles associated with respective seniority labels and the percentage ranges stored in a seniority pyramid structure. As explained above, a seniority pyramid is a hierarchical structure comprising a plurality of seniority levels, where each seniority level is associated with a percentage range of member profiles that belong to that seniority level. The inferred seniority system 144 may utilize different seniority pyramid structures generated for different industries. One or more seniority pyramid structures may be stored in the database 150 as seniority pyramids 154. An example inferred seniority system 144 is illustrated in FIG. 2.

FIG. 2 is a block diagram of a system 200 to infer seniority level of a social network member, in accordance with one example embodiment. As shown in FIG. 2, the system 200 includes a seniority label detector 210, a percentage module 220, an access module 230, a pyramid module 240, and a seniority level detector 250. The seniority label detector 210 may be configured to examine information in a plurality of member profiles in an on-line social network system to identify those member profiles from the plurality of member profiles that are associated with a particular seniority label from a plurality of seniority labels. The seniority label detector 210 may be configured to examine a title string from a title section of a member profile to detect a seniority indicator and, based on the seniority indicator, determine the seniority label for the member profile. The seniority label detector 210 may also be configured to determine a seniority label member profile utilizing data from a skills section of the member profile. The seniority label detector 210 may also be configured to generate a list comprising a plurality of seniority labels, utilizing data from respective title sections in a given set of member profiles.

The percentage module 220 may be configured to determine a percentage of the member profiles from the plurality of member profiles that are associated with the first seniority label. The access module 230 may be configured to access a hierarchical structure. As explained above, a hierarchical structure may be generated for a particular industry and may comprise a plurality of seniority levels, where a seniority level from the plurality of seniority levels indicates a percentage range associated with that seniority level. The pyramid module 240 may be configured to identify a seniority level in the hierarchical structure that corresponds to a particular percentage of member profiles that are associated with a particular seniority label. The pyramid module 240 may also be configured to generate the hierarchical structure based on a subset of member profiles in the on-line social network system, the subset of member profiles associated with a particular industry. The hierarchical structure may be generated based on a subset of member profiles in the on-line social network system, where the subset of member profiles is associated with a particular industry. The pyramid module 240 may be configured to access a member profile in the on-line social network system, determine that the member profile includes employer information associated with the particular industry and identify the member profile as being included in the subset of member profiles associated with the particular industry.

The seniority level detector 250 may be configured to identify that a certain seniority level corresponds to the first seniority label and to associate the member profiles with that seniority level. The seniority level detector 250 may also be configured to determine that a job listing, an advertisement, or a news article is associated with a certain seniority level in a seniority pyramid structure.

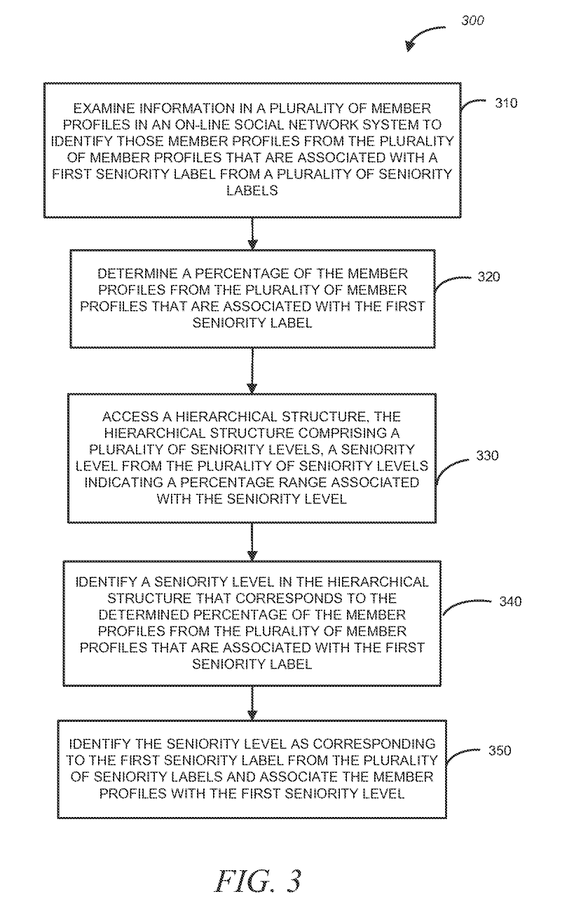

Also shown in FIG. 2 are a storage module 260 and a presentation module 270. The storage module 260 may be configured to store respective indicators the associated seniority levels in member profiles. The presentation module 270 may be configured to present a job listing, advertisements, or news articles associated with a particular seniority level to members represented by respective member profiles that are associated with the same or comparable seniority levels. Some operations performed by the system 200 may be described with reference to FIG. 3.

FIG. 3 is a flow chart of a method 300 to infer seniority level of a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the seniority label detector 210 of FIG. 2 examines information in a plurality of member profiles in an on-line social network system to identify those member profiles from the plurality of member profiles that are associated with a particular seniority label from a plurality of seniority labels. At operation 320, the percentage module 220 of FIG. 2 determines a percentage of the member profiles from the plurality of member profiles that are associated with the first seniority label. The access module 230 of FIG. 2 accesses a hierarchical structure at operation 330. At operation 340, the pyramid module 240 of FIG. 2 identifies a seniority level in the hierarchical structure that corresponds to a particular percentage of member profiles that are associated with a particular seniority label. The seniority level detector 250 of FIG. 2 identifies that a certain seniority level corresponds to the first seniority label and to associates the member profiles with that seniority level, at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules.

The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

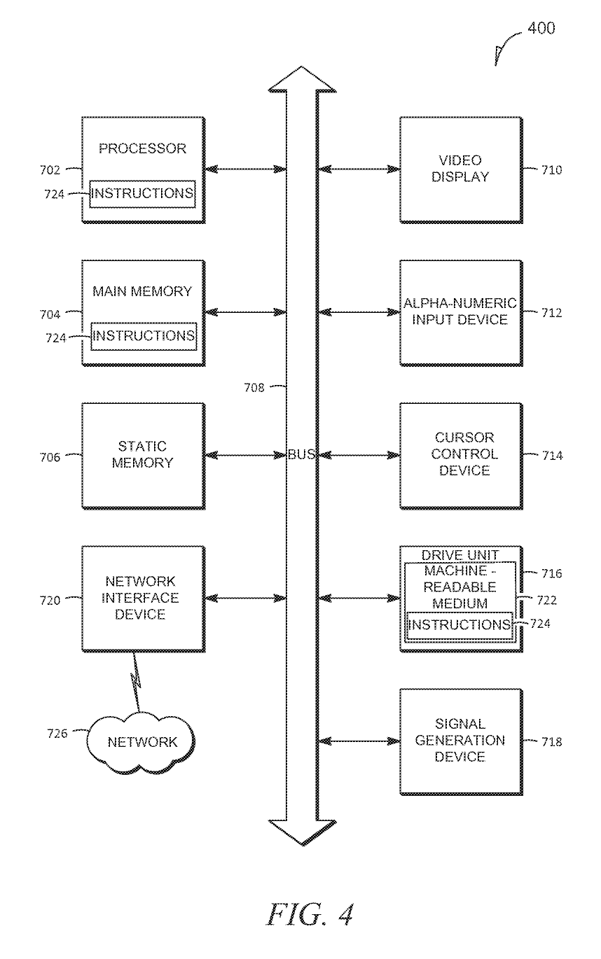

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to infer seniority of a social network member has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A method comprising:
examining, information in a plurality of member profiles in an on-line social network system to identify those member profiles from the plurality of member profiles that are associated with a first seniority label from a plurality of seniority labels;
determining a percentage of the member profiles from the plurality of member profiles that are associated with the first seniority label;
accessing a hierarchical structure, the hierarchical structure comprising a plurality of seniority levels, a seniority level from the plurality of seniority levels indicating a percentage range associated with the seniority level;
identifying, using at least one processor coupled to a memory, a seniority level in the hierarchical structure that corresponds to the determined percentage of the member profiles from the plurality of member profiles that are associated with the first seniority label;
identifying the seniority level as corresponding to the first seniority label from the plurality of seniority labels; and
associating the member profiles with the first seniority level.

2. The method of claim 1, comprising storing an indicator of the seniority level in each of the plurality of member profiles.

3. The method of claim 1, comprising presenting a job listing associated with the seniority level to members represented by respective member profiles that are associated with the seniority level.

4. The method of claim 3, comprising determining that the job listing is associated with the determined seniority level.

5. The method of claim 1, comprising presenting an advertisement associated with the seniority level to members represented by respective member profiles that are associated with the seniority level.

6. The method of claim 1, wherein determining that a first member profile from the plurality of member profiles is associated with the first seniority label comprises:
examining a title string from a title section of the first member profile to determine a seniority indicator;
based on the seniority indicator, determine the first seniority label from the list of seniority labels.

7. The method of claim 1, comprising determining that a first member profile from the plurality of member profiles is associated with the first seniority label utilizing data from a skills section of the first member profile.

8. The method of claim 1, comprising generating a list comprising the plurality of seniority labels, utilizing data from respective title sections in the plurality of member profiles.

9. The method of claim 1, comprising generating the hierarchical structure based on a subset of member profiles in the on-line social network system, the subset of member profiles associated with a particular industry.

10. The method of claim 9, comprising:
accessing a member profile in the on-line social network system;
determining that the member profile includes employer information associated with the particular industry; and
identifying the member profile as being included in the subset of member profiles associated with the particular industry.

11. A computer-implemented system comprising:
a seniority label detector to examine information in a plurality of member profiles in an on-line social network system to identify those member profiles from the plurality of member profiles that are associated with a first seniority label from a plurality of seniority labels, using the at least one processor;
a percentage module to determine a percentage of the member profiles from the plurality of member profiles that are associated with the first seniority label, using the at least one processor,
an access module to access a hierarchical structure, the hierarchical structure comprising a plurality of seniority levels, a seniority level from the plurality of seniority levels indicating a percentage range associated with the seniority level, using the at least one processor;
a pyramid module to identify a seniority level in the hierarchical structure that corresponds to the determined percentage of the member profiles from the plurality of member profiles that are associated with the first seniority label, using the at least one processor; and
a seniority level detector to identify the seniority level as corresponding to the first seniority label from the plurality of seniority labels and to associate the member profiles with the first seniority level, using the at least one processor.

12. The system of claim 11, comprising a storage module to store an indicator of the seniority level in each of the plurality of member profiles.

13. The system of claim 11, comprising a presentation module to present a job listing associated with the seniority level to members represented by respective member profiles that are associated with the seniority level.

14. The system of claim 13, wherein the seniority level detector is to determine that the job listing is associated with the determined seniority level.

15. The system of claim 11, comprising a presentation module to present an advertisement associated with the seniority level to members represented by respective member profiles that are associated with the seniority level.

16. The system of claim 11, wherein the seniority label detector is to:
examine a title string from a title section of the first member profile to determine a seniority indicator, and
based on the seniority indicator, determine the first seniority label from the list of seniority labels.

17. The system of claim 11, wherein the seniority label detector is to determine that a first member profile from the plurality of member profiles is associated with the first seniority label utilizing data from a skills section of the first member profile.

18. The system of claim 11, wherein the seniority label detector is to generate a list comprising the plurality of seniority labels, utilizing data from respective title sections in the plurality of member profiles.

19. The system of claim 11, wherein the pyramid module is to generate the hierarchical structure based on a subset of member profiles in the on-line social network system, the subset of member profiles associated with a particular industry.

20. A machine-readable non-transitory storage medium having instruction data to cause a machine to:
examine information in a plurality of member profiles in an on-line social network system to identify those member profiles from the plurality of member profiles that are associated with a first seniority label from a plurality of seniority labels;
determine a percentage of the member profiles from the plurality of member profiles that are associated with the first seniority label;
access a hierarchical structure, the hierarchical structure comprising a plurality of seniority levels, a seniority level from the plurality of seniority levels indicating a percentage range associated with the seniority level;
identify a seniority level in the hierarchical structure that corresponds to the determined percentage of the member profiles from the plurality of member profiles that are associated with the first seniority label; and
identify the seniority level as corresponding to the first seniority label from the plurality of seniority labels and to associate the member profiles with the first seniority level.
